(19) United States
(12) Patent Application Publication
(10) Pub. No.: US 2004/0188539 A1
(43) Pub. Date: Sep. 30, 2004

(54) Cleaning device with removable snap-on head

(76) Inventors: Douglas A. Soller, Racine, WI (US); Dale Aberegg, Mount Vernon, OH (US); Cathal L. Fahy, Columbus, OH (US)

Correspondence Address: S.C. JOHNSON & SON, INC., 1525 HOWE STREET, RACINE, WI, 53403-2236, US

(21) Appl. No.: 10/818,034

(22) Filed: Apr. 5, 2004

Related U.S. Application Data
(63) Continuation-in-part of application No. 10/385,982, filed on Mar. 10, 2003.

(51) Int. Cl. A47L 13/20; A47L 17/00; A47K 7/02; B05B 3/00; A47L 1/06

(52) U.S. Cl. 239/228

(57) ABSTRACT

A trigger actuated aerosol spray cleaning device is disclosed that has a removable snap-on cleaning head. The cleaning head can be snapped onto a handle by simple linear movement, and then can be removed by sliding a button. In one form, there is a lower connector on a mop handle that has two pivot pins biased apart by a spring. The pins have cammed ends that can be driven in towards each other as the mop handle is pressed against a receiver portion of the cleaning head. The cleaning head can then be removed by sliding a button connected to one of the pins to dislodge that pin from its pivot mount.

### CROSS-REFERENCE TO RELATED APPLICATIONS

This application is a continuation-in-part application of U.S. patent application Ser. No. 10/385,982, filed on Mar. 10, 2003.

### STATEMENT OF FEDERALLY SPONSORED RESEARCH/DEVELOPMENT

Not applicable.

### FIELD OF THE INVENTION

The present invention relates to cleaning devices and in particular to mop-like cleaning devices that permit cleaning heads to be easily attached and removed.

### BACKGROUND OF THE INVENTION

A variety of mopping devices have been developed which permit a mop head to be removably attached to a mop handle (to facilitate changing of the head when desired). It is desirable for the consumer not to have to touch the mop head when it is being replaced, as at that point the head may be soiled and/or wet. Also, it is desirable that the mechanism for attachment and/or removal be intuitive so that the consumer does not need special training to use it.

Further, it is desirable that the assembly provide a secure connection, preferably one that permits desired pivoting and/or swiveling of the mop head. Moreover, it is desirable that the attachment of the head to the mop handle be achievable using a simple motion rather than a complex motion. Another desirable feature is that the mop handle be connectable to the cleaning head with minimal requirement for the consumer to bend down to achieve the assembly. Also, it is desirable that these goals be achieved inexpensively and provide a secure connection.

Known prior art mop assembly systems are typically deficient, or at least not optimal with regard to at least some of these desirable features. For example, U.S. Pat. No. 3,362,037 discloses a mop head that can pivot on a horizontal axis and also can swivel on a second axis extending laterally through the mop handle. The mop handle is attached to the head by a consumer pushing a rod against a spring to reduce the effective width of the lower end of the handle. The consumer then tips an opposed prong of the handle end to insert it into a holder on the head, tips the rod down, and then releases the rod. This multi-motion procedure for attachment is somewhat complex, and may be difficult for certain consumers to understand.

U.S. Pat. No. 1,557,473 relies on a series of downwardly extending forks which can be flexed towards each other and then released to attach the fork bottoms to the cleaning head. Apart from the concerns involved in relying on the absence of metal fatigue over long term to insure a secure connection, some consumers may have difficulty in squeezing the forks sufficiently, particularly if they have arthritis.

U.S. Pat. No. 6,551,001 discloses another type of mop. Its mop handle also carries an aerosol can which sprays cleaning liquid in front of the cleaning head as the mop is used. While the connection between the mop handle and the cleaning head is a universal joint, the connection is designed to be more permanent nature once the connection is achieved. This is because the system was designed to make the head essentially permanent, while having a replaceable sheet be used that can be mounted on the head. However, in some cases it is desirable for the entire head to be replaced (e.g. if the device is being converted from a mop to a window cleaner).

Additional techniques for mounting cleaning heads to handles are disclosed in U.S. Pat. Nos. 5,692,855, 5,926,896 and 6,523,213. The disclosures of these patents, and all other publications referred to herein, are hereby incorporated by reference as if fully set forth herein.

Hence, a need still exists for providing improved assemblies that connect a mop handle to a mop head.

### SUMMARY OF THE INVENTION

The invention provides a cleaning device having a handle having a lower connection portion with a pair of connecting pins that are resiliently biased outward in opposed directions, and a cleaning head having an upper connection portion. The handle can be connected to the cleaning head by moving the lower connection portion in a linear manner down against the upper connection portion to thereby cause a snap lock connection therebetween. When so connected the handle is mounted to pivot relative to the cleaning head on a horizontal axis, and preferably is also mounted to swivel relative to the cleaning head on an axis perpendicular to a plane in which the horizontal axis lies.

In preferred forms the lower connection portion has a pair of connecting pins, with the pins being resiliently biased outward in opposed directions. Outward ends of both of the pins are cammed so as to cause the pins to move inward towards each other as the lower connection portion is pressed against the upper connection portion. Also, at least one of the pins can be manually slid against spring pressure towards the other pin to facilitate release of the handle from the cleaning head. In specific forms of this embodiment the manually slidable pin can be linked to a button having a dished portion, where the button has a leg that engages the manually slidable pin.

The invention is particularly suitable for cleaning devices such as where the handle is further linked to an aerosol canister assembly for delivering a chemical from the canister assembly to a desired location adjacent the cleaning head, the cleaning head is designed for mopping, and the device further has a replacement cleaning head designed for wall or window cleaning.

It will be appreciated that the present invention permits assembly of the handle (and associated cleaning fluid dispenser) to the cleaning head by simple linear motion. The consumer can leave the cleaning head on the floor and hold the handle by the top of the handle as the lower end of the handle is being driven against the top of the cleaning head. Hence, the consumer does not need to bend down to create the connection, or learn multiple different motions to achieve the connection.

The connection is secure, albeit when desired sliding movement of a release button can decouple the head from the handle. The coupling assembly is relatively inexpensive to produce, reliable, and is particularly well suited for use with handles that also have a second swivel axis.

These and other advantages of the invention will be apparent from the detailed description which follows and the accompanying drawings. It should be understood that the following merely describes preferred embodiments of the invention. The claims should be looked to in order to understand the full scope of the invention.

### BRIEF DESCRIPTION OF THE DRAWINGS

FIG. 1 is a perspective view of a cleaning device incorporating the present invention;

FIG. 2 is a side view of the cleaning device with an extension wand and remote grip assembly removed;

FIG. 3 is an exploded perspective view of the cleaning device as shown in FIG. 1;

FIG. 4 is a top view of the cleaning device as shown in FIG. 2;

FIG. 5 is a partial cross-sectional view taken along line 5-5 of FIG. 4;

FIG. 6 is a partial perspective view of the cleaning head;

FIG. 7 is an exploded perspective view showing a quick disconnect coupler separated from the cleaning head;

FIG. 8 is a partial cross-sectional view taken along line 8-8 of FIG. 6;

FIG. 9 is a partial plan view showing the coupler without the cleaning head;

FIG. 10 is an opposite side plan view of the coupler;

FIG. 11 is an exploded perspective view of the coupler;

FIG. 12 is a reverse exploded perspective view of the coupler;

FIG. 13 is a partial detail cross-sectional view taken along line 13-13 of FIG. 4 showing the swivel connection of the coupler with a swivel locking element in an unlocked position;

FIG. 14 is a view similar to FIG. 13 although showing the swivel locking element in a locked position disabling swivel movement;

FIG. 15 is a partial detail cross-sectional view taken along line 15-15 of FIG. 14;

FIG. 16 is a bottom plan view of a coupler body isolated from the swivel and swivel locking element;

FIG. 17 is a side cross-sectional view taken along line 17-17 of FIG. 11;

FIG. 18 is an exploded perspective view of a latch ring;

FIG. 19 is a partial cross-sectional taken along line 19-19 of FIG. 9 showing a plug end of a main body of the device locked into a socket end of the coupler;

FIG. 20 is a view similar to FIG. 19 showing the latch ring moved into a release position out of engagement with the plug end;

FIG. 21 is a view similar to FIG. 19 showing the plug and socket arrangement disconnected;

FIG. 22 is a partial perspective view of a second embodiment of the device having a quick disconnect coupler with opposing spring biased jaws;

FIG. 23 is a partial cross-sectional view taken through line 23-23 of FIG. 22;

FIG. 24 is a front perspective view of another embodiment of the device having a removable snap-on adjustable cleaning head;

FIG. 25 is a partial back view of the cleaning head and the main body of the device;

FIG. 26 is a front view thereof;

FIG. 27 is a partial perspective view showing the sliding canister mount on the body of the device;

FIG. 28 is a partial front perspective view showing the adjustable connection of the cleaning head of the device of FIG. 24;

FIG. 29 is a view similar to FIG. 28 albeit illustrating the swivel action of the cleaning head with respect to the body of the device;

FIG. 30 is a partial exploded view of a lockable pivot connection between the cleaning head and the body of the device;

FIGS. 31 and 32 are partial side sectional views taken along line 31-31 of FIG. 28 showing the cleaning head in different pivotal positions;

FIG. 33 is an enlarged partial section view of the pivot connection;

FIG. 34 is a front sectional view taken along line 34-34 of FIG. 31 showing the pivot connection with the cleaning head pivotally locked to the body of the device, the body of the device is shown disassembled from the cleaning head in phantom;

FIG. 35 is an enlarged partial section view showing a thumb lever retracting a pin of the pivot connection for release of the cleaning head from the body of the device;

FIG. 36 is a cut-away sectional view looking down at the pivot assembly;

FIG. 37 is a view similar to FIG. 35 showing the straight on snap in connection of the cleaning head to the device.

### DETAILED DESCRIPTION OF THE PREFERRED EMBODIMENTS

The present invention provides a trigger actuated cleaning device using an aerosol spray canister to dispense a cleaning agent. The primary focus of this application is a quick disconnect coupler for the cleaning head allowing it to pivot with at least two degrees of freedom. The other components of the cleaning device will be described briefly here, however, a better understanding of a device with similar components can be found in co-pending U.S. application Ser. No. 09/951,632, filed on Sep. 14, 2001 (now allowed), which is hereby incorporated by reference as though fully set forth herein.

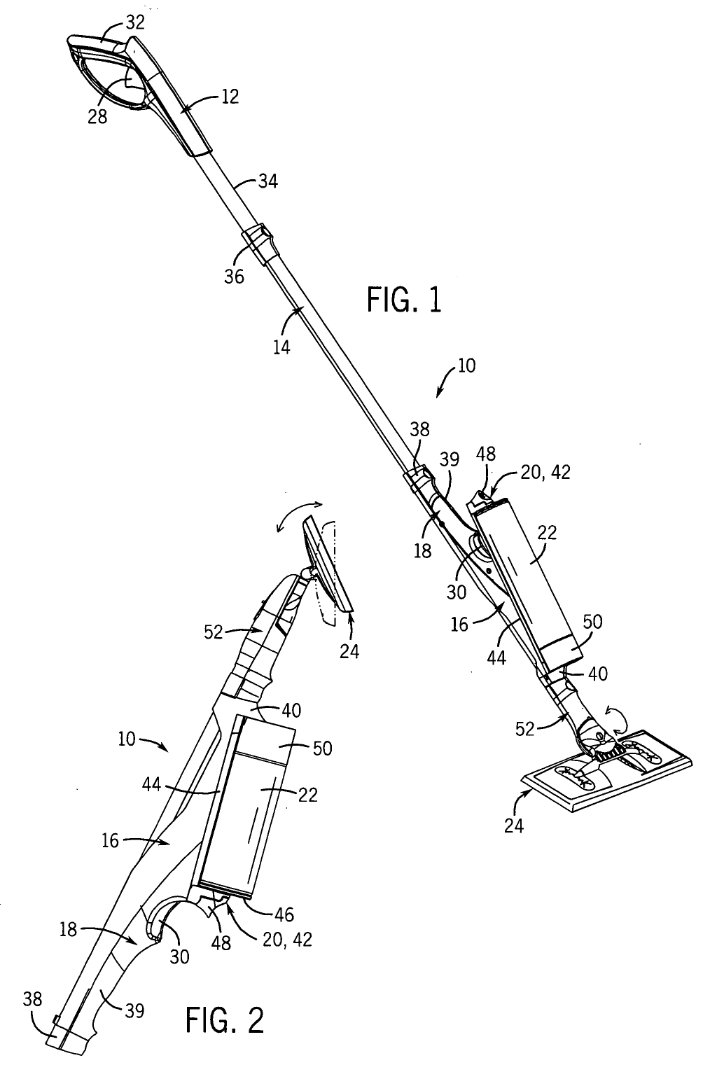

FIG. 1 of the drawings shows the cleaning device 10 of the present invention fully assembled in a mop-like configuration for cleaning floors or out of reach vertical or horizontal surfaces. FIG. 2 shows the cleaning device 10 with an extension wand removed so as to be shorter for cleaning nearby surfaces and to be more suitable for holding upright when cleaning close vertical surfaces, such as windows for example.

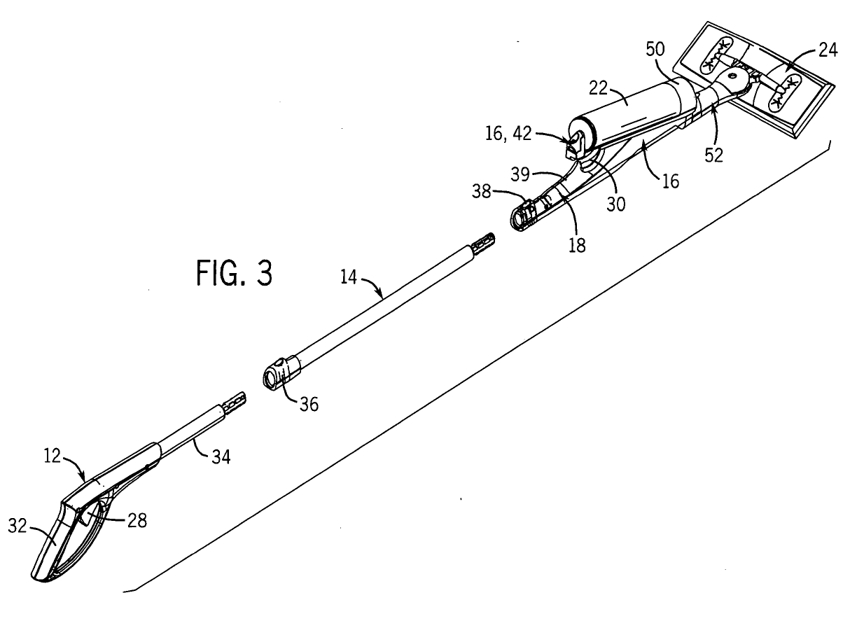

With reference to these two figures and FIG. 3, the cleaning device 10 includes as major components a remote grip assembly 12, an extension wand 14, a main body 16 having its own grip assembly 18 and an adjustable retainer assembly 20 holding a canister 22, and a cleaning head 24. Internal to many of these components is a movable actuator assembly (not shown) linking triggers 28 and 30 of the two grip assemblies 12 and 18, respectively, to the valve of the canister 22 for spraying cleaner contained therein near the cleaning head 24.

The remote grip assembly 12 includes a hollow (two-piece) plastic pistol grip housing defining a handle 32 and the pivotally mounted trigger 28 to be operable by an index finger when gripping the handle 32. A hollow shaft extension 34 which plugs into a quick connect socket 36 at one end of the extension wand 14. Similarly, the opposite end of the extension wand 14 plugs into a quick connect socket 38 at the end of the main body 16. The ends of the shaft extension 34 and the extension wand 14 are identical as are the sockets 36 and 38, thus if desired, the extension wand 14 can be removed from the assembly so that the remote grip assembly 12 can by directly connected to the main body 16. As mentioned above and shown in FIG. 2, the remote grip assembly 12 and the extension wand 14 can be detached and the device operated by trigger 30 and held by handle 39 of the main body 16. The grip assembly 12, the extension wand 14 and the main body 16 houses core pieces (not shown) of the actuator assembly that slide in response to movement of either of the triggers 28 and 30 and in turn pivot an actuator lever (not shown) operating the valve of the canister 22.

The canister 22 is aligned and mounted to the main body 16 by the retainer assembly 20, having a toe stop 40, through which an end of the actuator lever protrudes when the triggers 28 and 30 are depressed, a T-shaped rail (not shown) and a heel assembly 42 having a slide 44 riding on the rail. A locking tab (not shown) formed in the rail clicks into one of two receivers at two preset adjustment locations to alternatively hold full or compact sized canisters. A mechanism at the back of the slide 44 has a spring biased latch (not shown) that engages an inside surface of a rim 46 at the bottom of the canister 22. The latch is operated by a thumb operated release lever 48, which when depressed clears the latch from the canister 22. Releasing the release lever 48 resets the latch so that another canister can be snapped in place.

In operation, a user generally utilizes the cleaning device like any conventional poled or hand-held cleaning aerosol device. When the user desires to spray cleaner onto the surface being cleaned, the user simply squeezes either trigger 28 or 30, which pivots a hinged part of an overcap 50 on the canister 22 which in turn moves a valve stem (not shown) to open the canister valve and spray out cleaner. When the triggers 28 and 30 are released, springs (not shown) bias the actuator assembly to its original, non-activated position, which allows the canister valve to close and stop spraying.

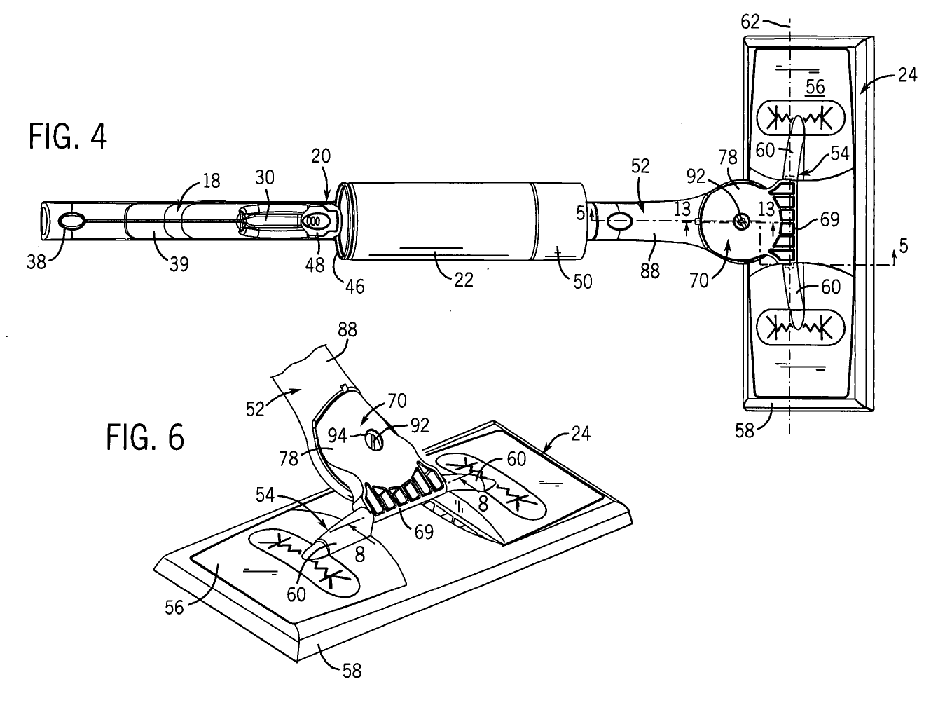

Referring now to FIGS. 4 and 6, the opposite end of the main body 16 connects to the cleaning head 24, as described in detail below, by a quick disconnect coupler 52 mounted to a pivot mount 54 formed as an integral part of the a backing plate 56 supporting a compressible pad 58. The pad 58 can be a substrate for mounting a cleaning cloth or dusting sheet or it may be a sponge or scrubber pad. The plate 56 and pad 58 could of course be replaced by a bristled brush head, wiper blade or any other suitable cleaning implement desired.

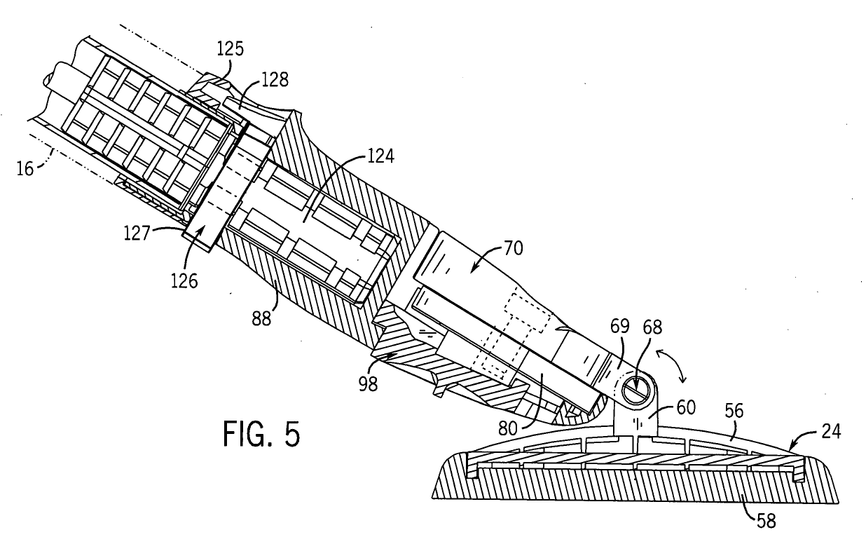

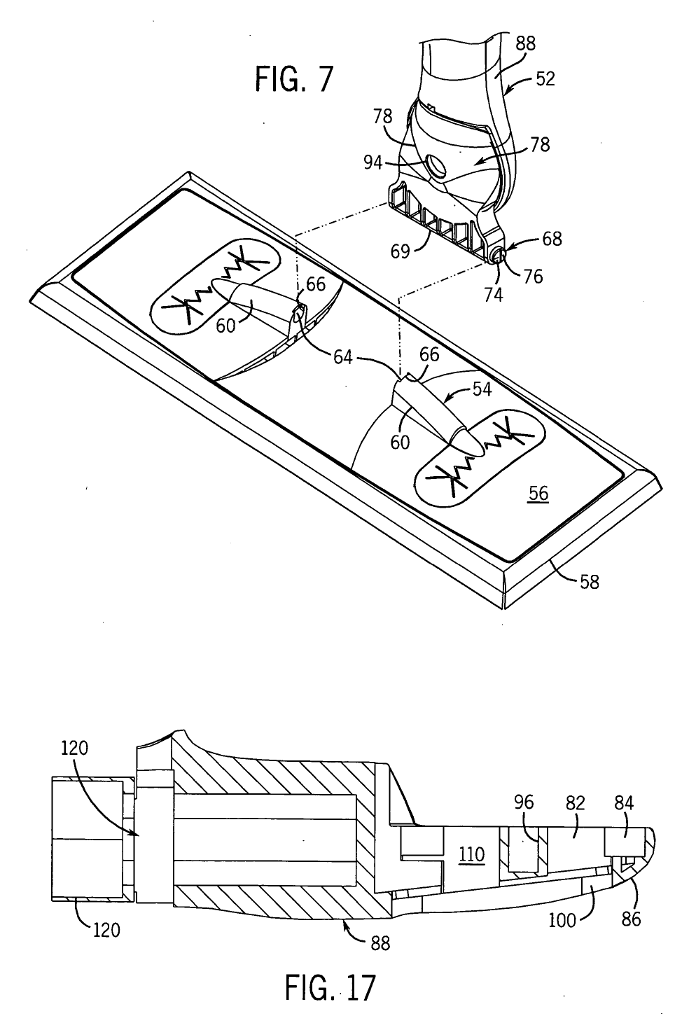

More specifically, referring to FIGS. 5-8, the pivot mount 54 is actually two upstanding fixed mounts 60 spaced apart along a pivot axis 62 defining facing pivot grooves 64 with upper notches 66. The two pivot grooves 64 are sized to receive two pivot bosses 68 on opposite lateral sides of a flared section 69 of a swivel 70 component of the coupler 52. The bosses 68 have tapered surfaces 74 that facilitate camming the pivot bosses 68 into the pivot grooves 54 through the notches 66 during assembly. The flat surfaces 76 of the pivot bosses 68, however, resist separation during normal use. Thus, when assembling or disassembling this pivot connection, the coupler 52 should be oriented so that the tapered surfaces 74 are the leading surfaces.

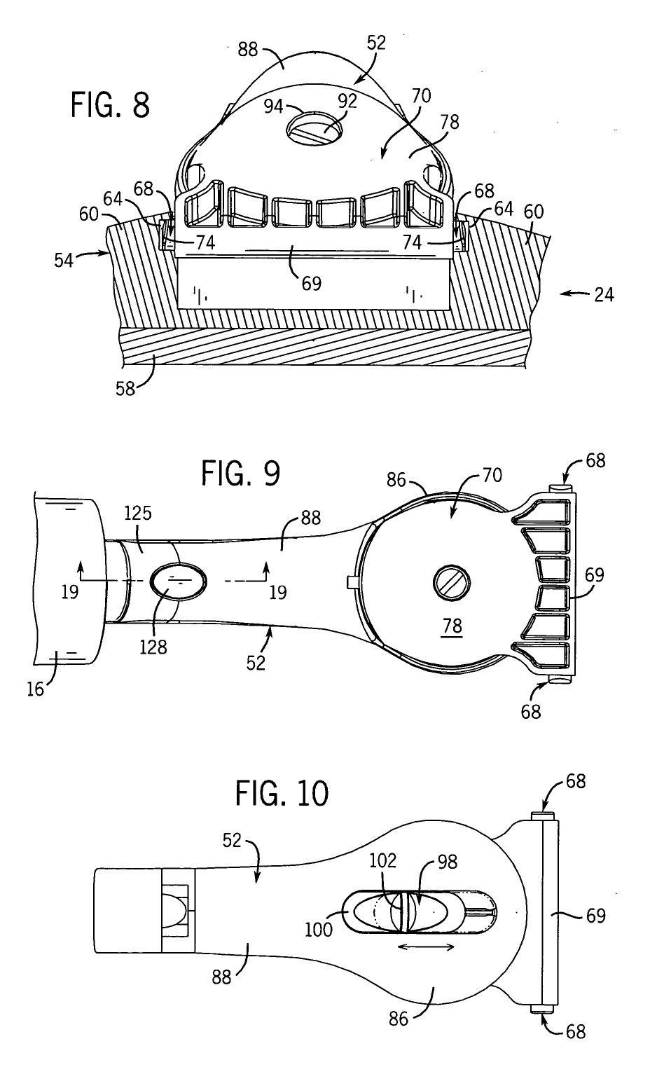

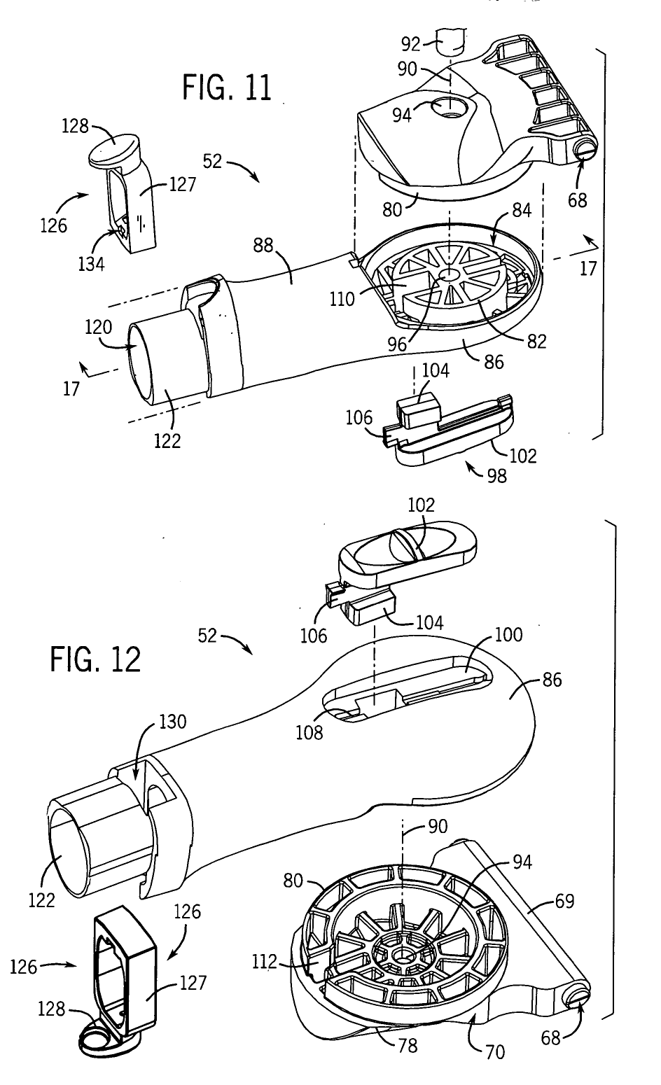

Referring to FIGS. 8-12 and 16, the swivel 70 has a generally circular section 78 with a ribbed ring 80 that fits around a hub 82 in an annular recess 84 at a round end 86 of a coupler body 88. The swivel 70 and coupler body 88 are pivotally joined along a swivel axis 90 by a fastener 92 disposed through a central opening 94 of the swivel 70 and threaded into a bore 96 of the coupler body 88. The swivel axis 90 is disposed in a plane generally perpendicular to the plane containing the pivot axis 62. Ordinarily, the coupler body 88 is free to pivot about the swivel axis 90 until the flared section 69 is stopped by contact with the sides of the coupler body 88.

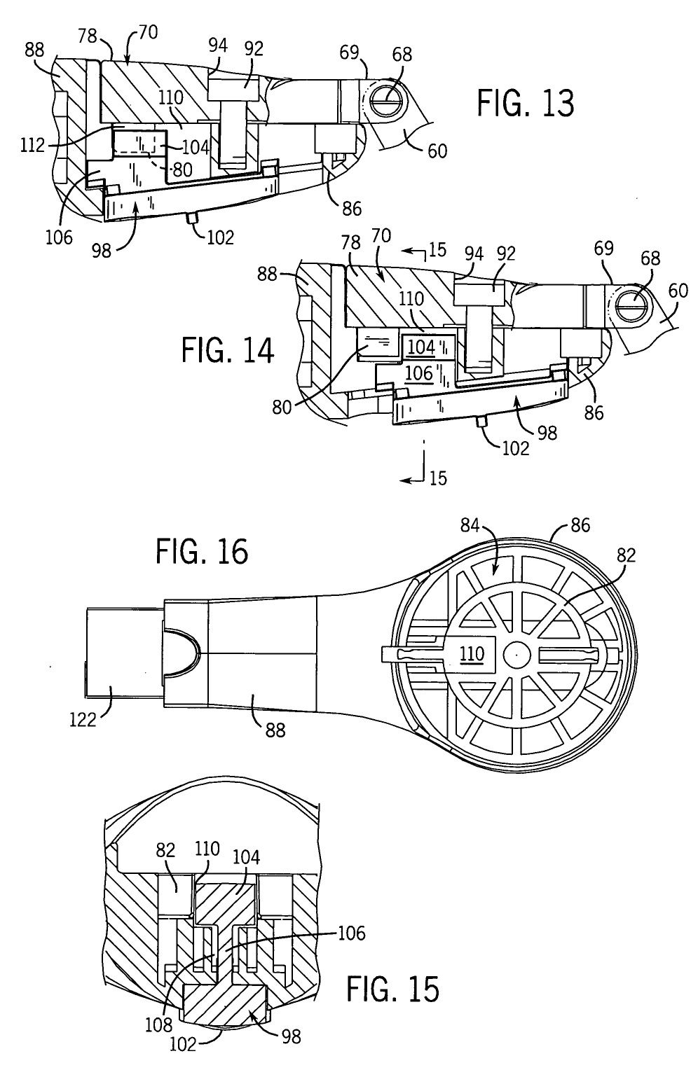

As shown in FIGS. 10-15, the coupler 52 includes a locking element 98 disposed in a recess 100 in the coupler body 88. The locking element 98 includes a grip section 102 and a stop 104 with a narrowed neck section 106 disposed through a slot 108 in the coupler body 88. The recess 100 and the slot 108 are longer than the respective grip 102 and neck 106 sections to permit the locking element 98 to slide between locked and unlocked positions with respect to the coupler body 88. As shown in FIGS. 14 and 15, when the locking element 98 is in the unlocked position, the stop 104 fits into a radial slot 110 in the hub 82 of the coupler body 88 clear from the ring 80 of the swivel 70. By sliding the locking element 98 to the locked position shown in FIG. 13, the stop 104 fits into a radial slot 112 in the ring 80 (aligned with slot 110) so as to interfere with the swivel 70 and prevent it from pivoting about swivel axis 90. This arrangement allows the swivel to be disabled quickly and easily when not needed or when a more rigid connection is desired.

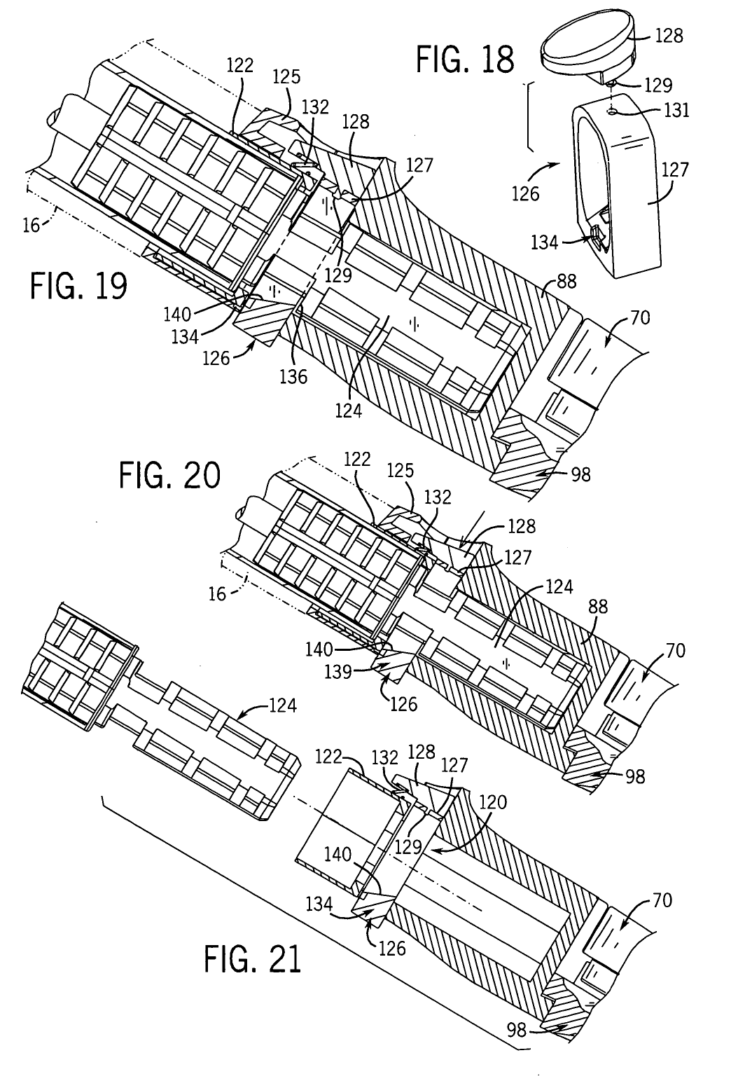

Referring now to FIGS. 5, 11-12 and 17-21, the opposite end of the coupler 52 provides a plug and socket type quick disconnect attachment with an end of the main body 16. In particular, the coupler 52 has a socket 120 with a tubular end 122 that receives a male plug end 124 of the main body 16 and fits inside of an end shroud 125 of the main body 16. The plug end 124 is retained in the socket 120 by a latch ring 126. As shown in FIG. 18, the latch ring 126 is generally ring-shaped element 127 with flat long sides and has a button 128 mounted at a short end by a snap-fit pin 129 and socket 131 connection. The latch ring 126 could, of course, be a single unitary component; however, it is shown in two parts here for ease of assembly. The latch ring 126 is slidably captured within a slot 130 in the coupler 52 and protrudes through opposite sides of the coupler 52. The latch ring 126 is biased by a spring 132 to be concentric with the main axis of the socket 120, as shown in FIGS. 5 and 19, so that a catch surface 134 of the latch ring 126 engages with a radial surface 136 of the plug end 124 to prevent axial separation of the main body 16 from the coupler 52.

The main body 16 can be quickly connected to the cleaning head 24 by sliding the plug end 124 into the socket 120. Doing so causes the radial surface 136 to cam against a ramped side 140 of the catch 134 and drive the latch ring 126 out of the way of the plug end 124, as shown in FIG. 20. Once the radial surface 136 passes the catch member 134 the spring 132 returns the latch ring 126 to its original position, as shown in FIG. 19. Depressing the button 128 against the spring 132 clears the catch member 134 from the radial surface 136 so that the plug end 1124 can be slid out of the socket 120, as shown in FIG. 21.

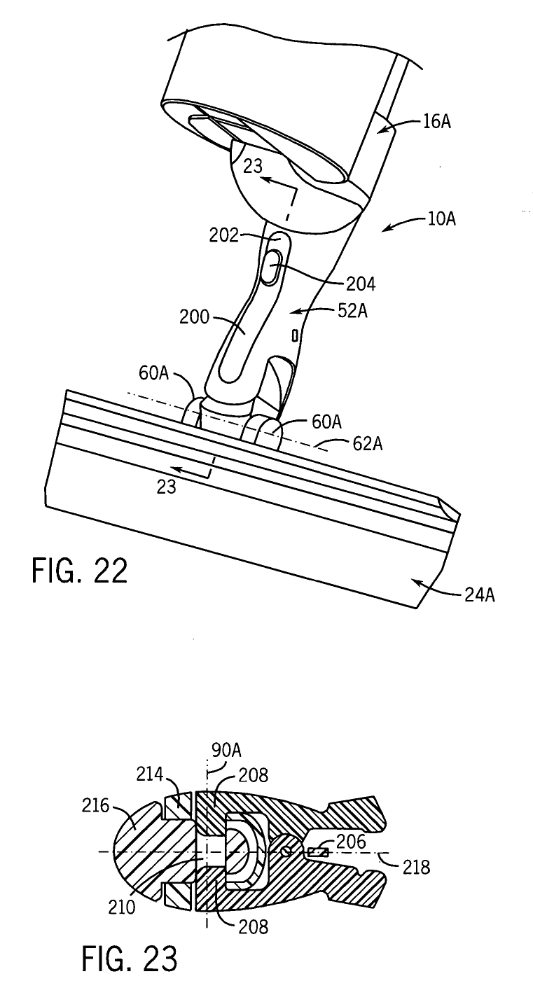

FIGS. 22 and 23 show an alternate embodiment of the cleaning device 10A of the present invention, shown here with a squeegee type cleaning head 24A and with a slightly modified main body 16A and retainer 20A assembly as well as an alternate coupler 52A assembly. Specifically, in this embodiment, the coupler 52A includes a coupler body 88A in which are pivotally mounted opposing jaws 200 having tail ends 202 with raised grips 204 biased outwardly by a spring 206. The spring 206 thus biases the jaws 200 to maintain teeth 208 in an opening 210 concentric with a swivel axis 90A of a swivel 212. Preferably, the swivel 212 has two parts 214 and 216 that are pivotally mated together about another swivel axis 218. The second part 216 is in turn pivotally mounted along a pivot axis 62A with spaced pivot mounts 60A fixed to the cleaning head 24A.

Depressing the grips 204 inwardly toward each other opens the jaws 200 and disengages the teeth 208 from the opening 210 in swivel part 212 so that the coupler 52A can be separated from the cleaning head 24A. The cleaning head 24A can be quickly reattached again by pressing in on the grips 204 and clamping the teeth 208 into the opening 210. This arrangement thus provides rapid connection and disconnection like the previously described embodiment. Also like before, this embodiment provides pivoting of the cleaning head 24A with respect to the main body 16A about two perpendicular pivot 62A and swivel 90A axes. In addition, it provides a fully 360 degree rotation about the third perpendicular swivel axis 218. Although not shown, various locking pins or other features could be provided to disable one or both of the swivel motions, as desired.

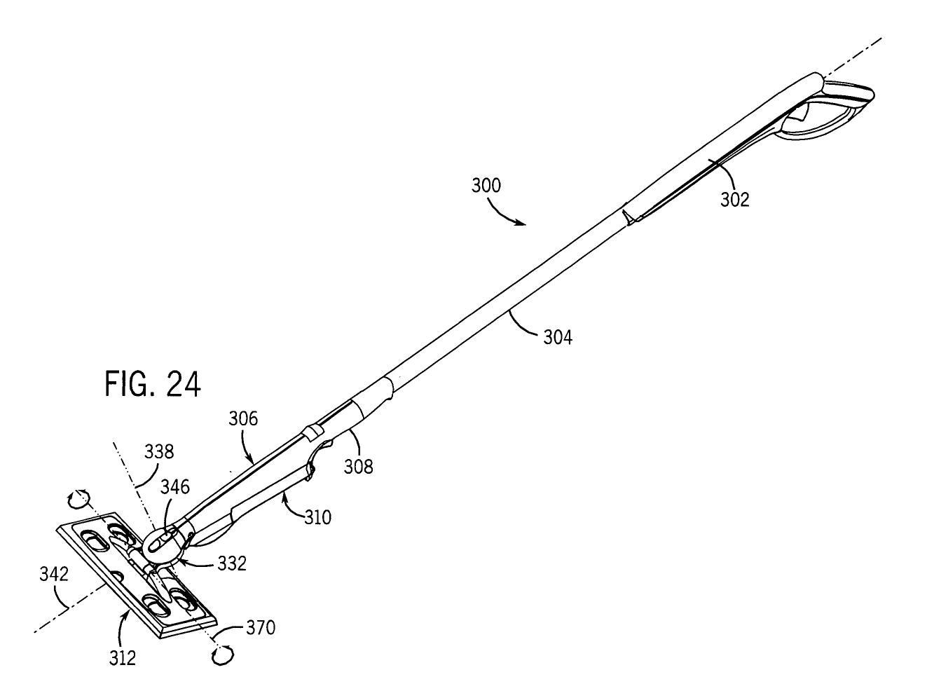

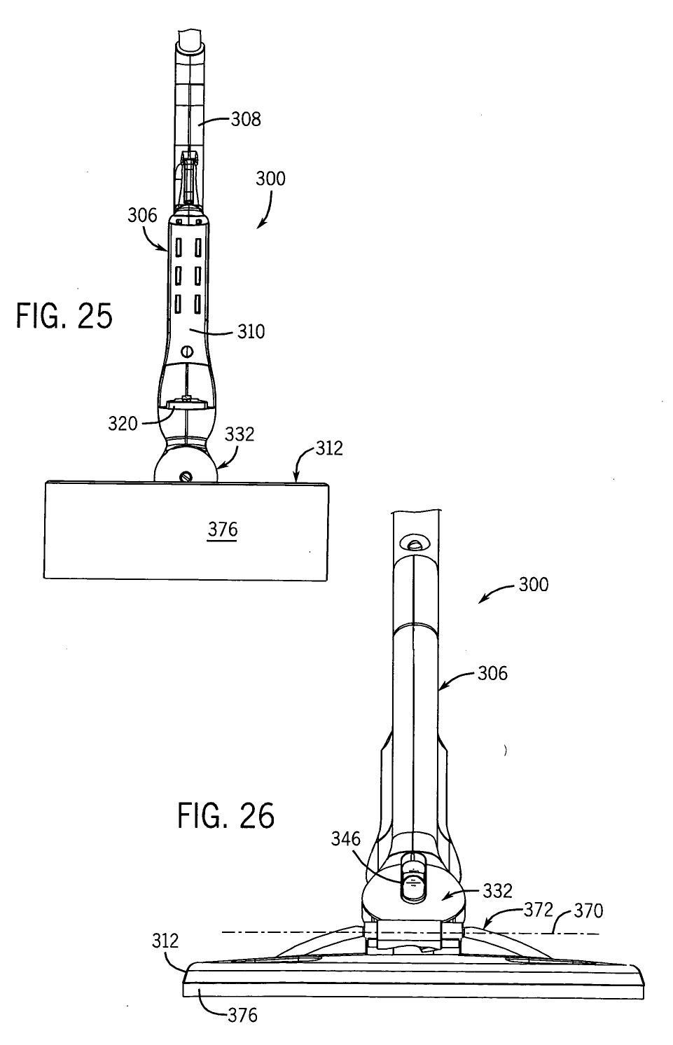

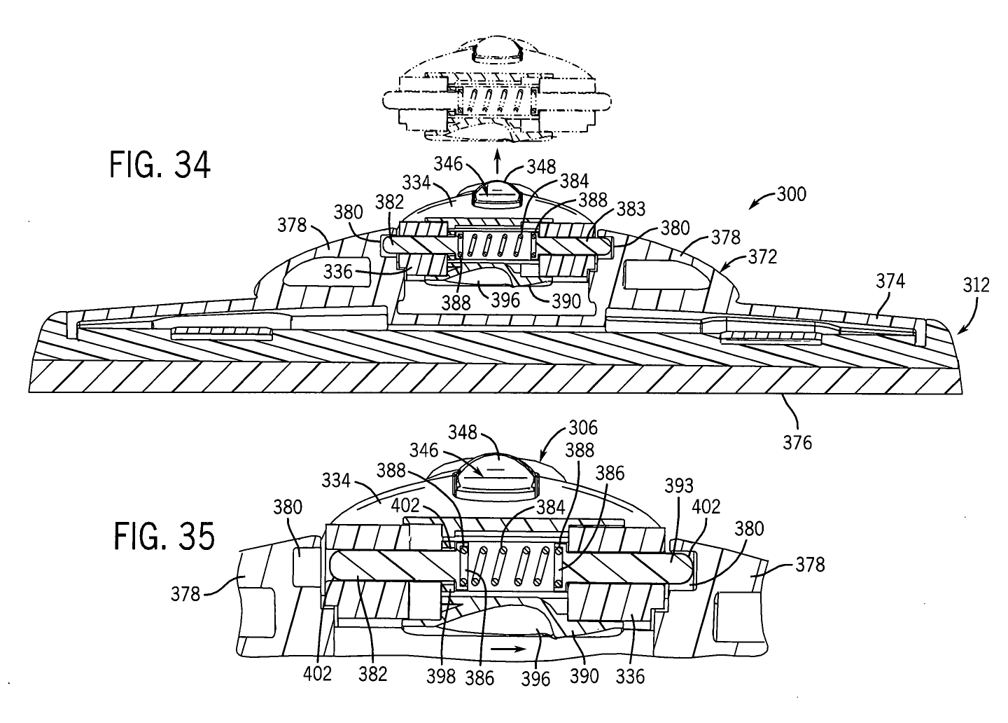

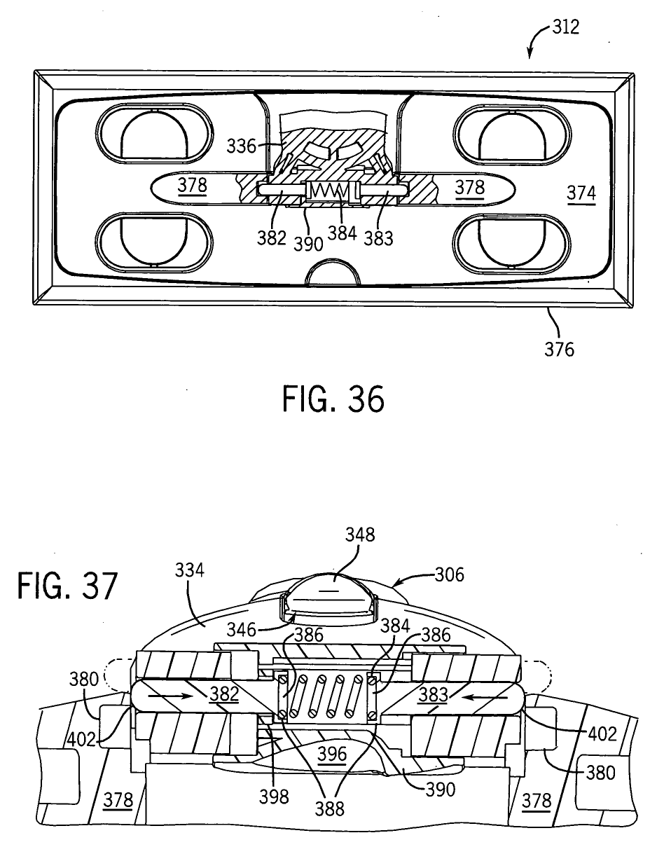

FIGS. 24-36 illustrate another version of the present invention in which the cleaning head is attached to the body of the device in a releasable pivot connection so that when attached it is free to pivot front to back with respect to the device. The pivot connection of this embodiment allows the cleaning head to be snapped onto the device in a straight on motion. Once attached, it is positively locked on while being free to pivot. The cleaning head can be removed by activating a release button or lever. In addition to the pivotal motion, the cleaning head preferably can also swivel from side to side or be locked into one of several preset (perpendicular or oblique) angular positions.

FIGS. 24-26 illustrate this embodiment of the cleaning device 300 of the present invention fully assembled in a mop-like configuration for cleaning floors or out of reach vertical or horizontal surfaces. Although not shown specifically in this embodiment, the device can take on a held-held configuration by removing an extension wand (similar to that shown in FIG. 2). This shorter configuration makes it easier to hold upright and to clean nearby surfaces.

Generally, the cleaning device 300 includes a remote grip assembly 302, an extension wand 304, a main body 306 having its own grip assembly 308 and an adjustable canister (like item 22 in FIG. 1) retainer assembly 310, and a cleaning head 312. The remote grip assembly 302 is generally the same as described above, having a hollow plastic pistol grip having a handle and a trigger. One or more hollow sections form the wand 304 and connect the remote grip 302 to the main body 306. Snap together and quick releasing socket connections allow for quick assembly and disassembly of the wand 304 and the remote grip 302. For a shortened device, the grip assembly 308 can be used, or the remote grip 302 can by directly connected to the main body 306 without the wand 304.

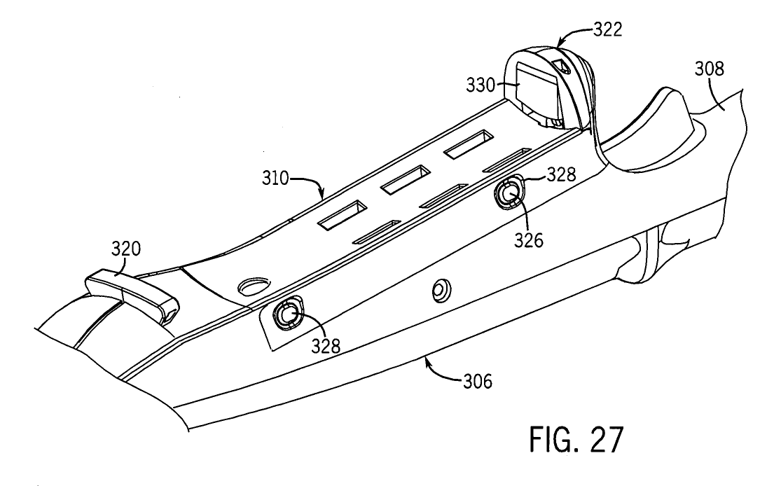

Within many of these components is a movable actuator assembly linking the triggers of the two grip assemblies to the valve of the canister for spraying cleaner contained therein near the cleaning head 312. Core pieces (not shown) of the actuator assembly slide in response to movement of either of the triggers and in turn pivot an actuator lever 314 to operate the valve of the canister. The canister is aligned and mounted to the main body 306 by the retainer assembly 310 (see FIG. 27), having a specially shaped toe stop 320, through which an end of the actuator lever protrudes when either of the triggers is depressed. A rail (not shown) mounts a heel assembly 322 having a slide 324 which rides on the rail. A locking tab 326 formed in the rail clicks into one of two receiver openings 328 at two preset adjustment locations to alternatively hold full or compact sized canisters. The canister is inserted into and removed from the retainer assembly 310 by depressing the locking tab 326 so that it clears the receiver opening thereby allowing the slide 324 to slide on the rail. Generally the slide 324 is moved away from the toe stop 320 to make room to insert the canister and then moved toward the toe stop 320 to clamp the canister in place. A spring biased latch 330 engages the inside of the bottom rim of the canister to prevent it from falling out when upside down.

In operation, a user generally utilizes the cleaning device 300 like any conventional poled or hand-held aerosol spray cleaning device. When desired, the user simply squeezes a trigger to move the hidden actuating linkage, which pivot a hinged part of an overcap on the canister to open the canister valve and spray out cleaner. When the trigger is released, a spring biases the actuator linkage to its original, non-activated position, which allows the canister valve to close and stop spraying.

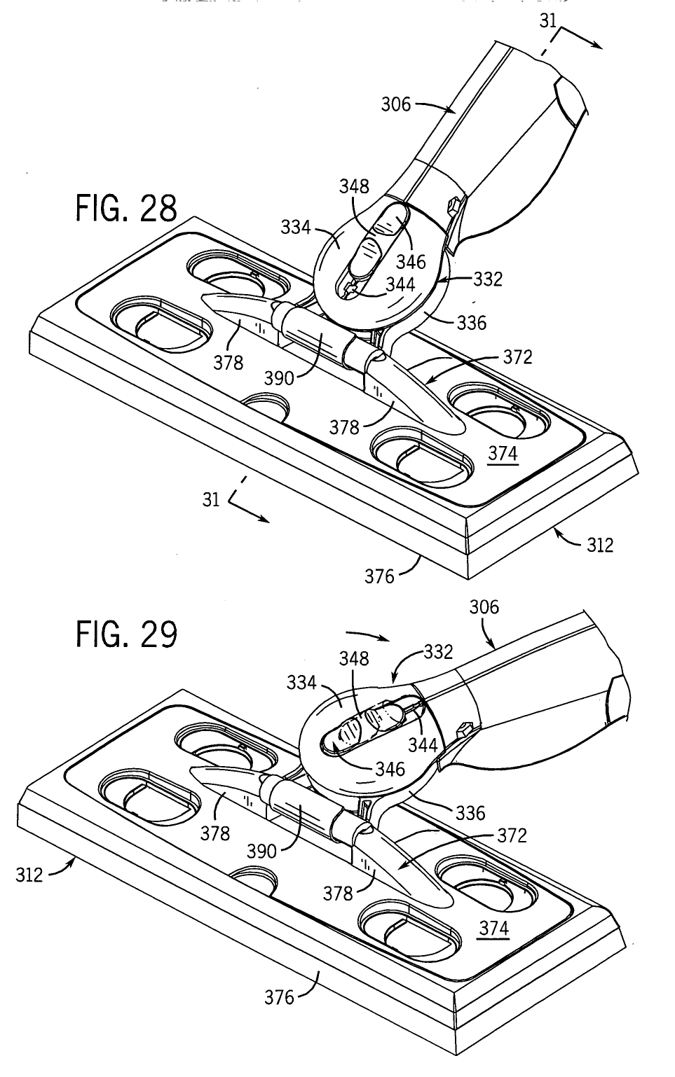

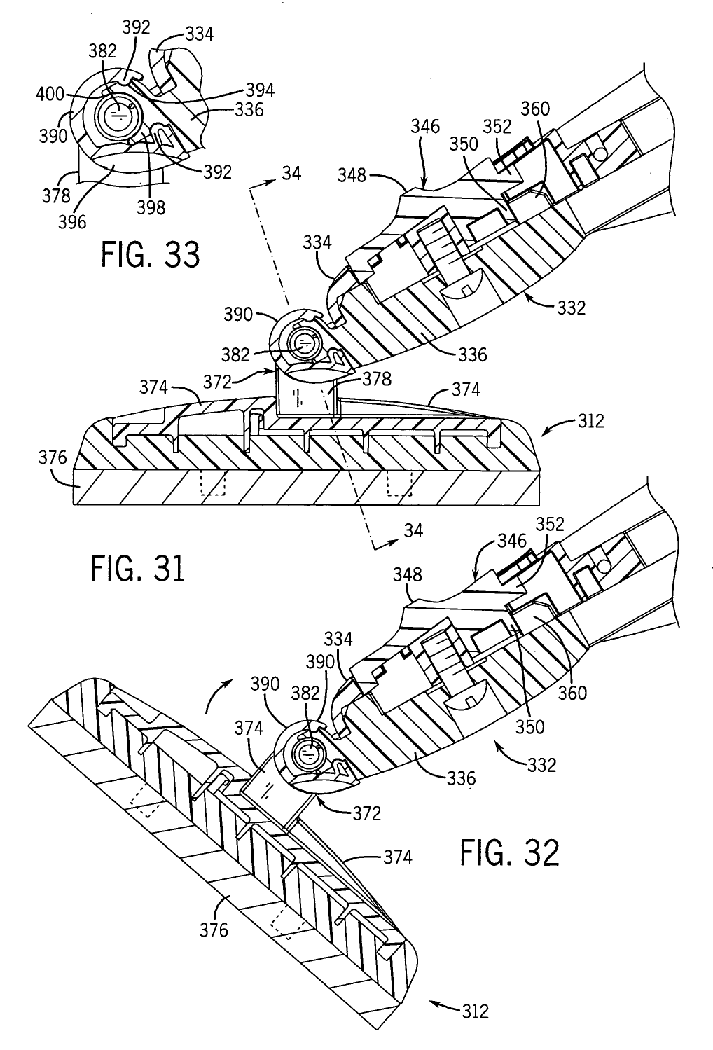

As shown in FIGS. 28-30, the opposite end of the main body 306 connects to the cleaning head 312 by a coupler 332. The coupler 332 provides for, as mentioned above, both side to side swiveling of the cleaning head 312 with respect to the body 306 as well as front to back pivotal motion. Generally, the coupler 332 includes a stationary (or non-swiveling) part 334 and a swivel 336. The swivel 336 is a separate component rotatably mounted to the stationary part 334 along a swivel axis 338 (see FIG. 24), for example by a pin, rivet or bolt. The stationary part 334 can be a separate part from the body 306 (as shown in FIG. 31) in which an end fits into a socket at the end of the body 306 and is fastened in place. Or, while not shown herein, the stationary part could be a unitary part of the body 306, for example formed integrally therewith in a single molding operation.

The stationary part 334 defines a slot 344 (see FIGS. 28 and 29) extending along a longitudinal axis 342 (see FIG. 24) in which a swivel lock 346 fits so it can slide between locked (FIG. 28) and swivel or unlocked (FIG. 29) positions. The swivel lock 346 has on outer grip 348 which extends to one side of the coupler and an internal stop 350 with a narrowed neck section 352. The swivel 336 has a round end that defines a generally circular section 360 extending axially concentric with the swivel axis 338. The circular section 360 defines one or more radial slots (not shown), spaced apart circumferentially if more than one. These slots are sized to accept the stop 350 of the swivel lock 346 when aligned with a longitudinal axis 342 of the body 306 (see FIG. 24) and when it is moved to the locked position. Having several of the slots allows the cleaning head to be rapidly locked in one of several angular positions with respect to the body 306. For example, there could be slots at approximately 10, 12 and 2 o'clock, in which the 12 o'clock slot is used to centered the cleaning head, that is to align it perpendicularly with the longitudinal axis 342 of the body 306. The other two slots allow the cleaning head to be held at an oblique (non-perpendicular) angle with respect to the body 306. Exemplary spacing of the slots would be between 10 and 45 degrees. The swivel 336 is thus locked and unlocked by simply sliding the swivel lock 346 up or down. When the swivel lock 346 is in the locked position, the stop 350 fits into the radial slot and interferes with movement of the radial surfaces defining the slot so as to prevent any meaningful rotation of the swivel 336. By sliding the swivel lock 346 to the swivel or unlocked position, the stop 350 clears the slot to allow rotation of the swivel 336. The angular position of the cleaning head 312 relative to the body 306 also can be quickly changed by sliding the swivel lock 346 to the unlocked position, rotating the swivel 336 to align one of the non-centering slots with the longitudinal axis and then re-locking the swivel 336. Registration markings can be provided on the swivel 336 and stationary part 334 to visually aid in alignment. A more detailed explanation and illustration of the swivel arrangement is provided in co-pending U.S. application entitled “Cleaning Device With Preset Lockable Swivel Head”, the entire disclosure of which is hereby incorporated by reference as though fully set forth herein.

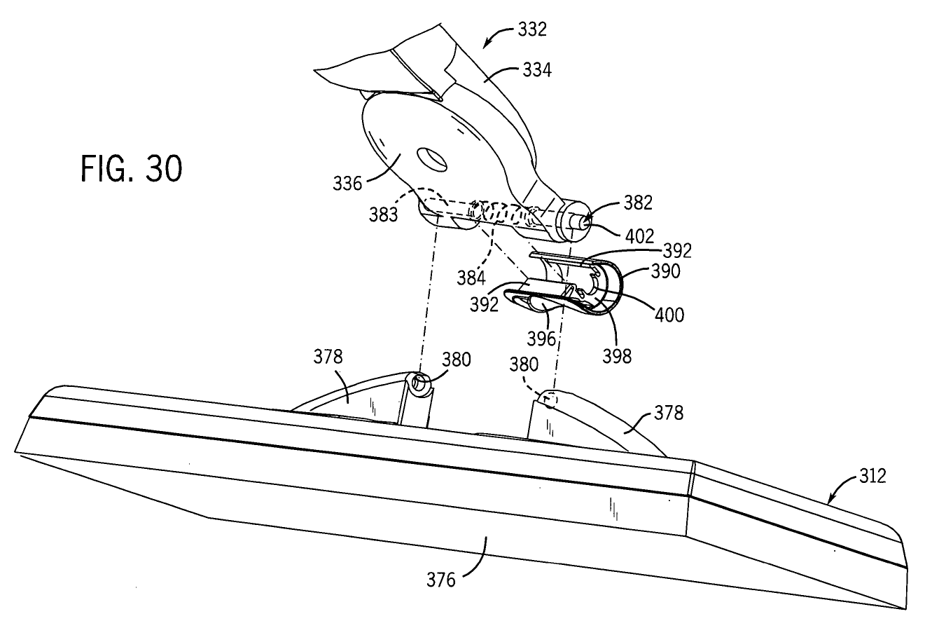

Referring to FIGS. 30-36, the cleaning head 312 is pivotally mounted to the swivel 336 about a pivot axis 370, which is perpendicular to the swivel axis 338. The cleaning head 312 has a pivot mount 372 formed as an integral part of a backing plate 374 supporting a compressible pad 376. It should be noted that as in prior embodiments, the pad 376 can be a substrate for mounting a cleaning cloth or dusting sheet or it may be a sponge or scrubber pad, and the backing plate 374 and pad 376 could be replaced by a bristled brush head, wiper blade or any other suitable cleaning implement desired.

In any event, the pivot mount 372 is formed by two upstanding fixed mounts 378 spaced apart along the pivot axis 370 and defining two facing pivot holes 380. These two pivot holes 380 receive two pivot pins 382 and 383 slidably housed in bores in a yoke end of the swivel 336. The pivot pins 382 and 383 are biased apart by a spring 384 received in pockets 386 in enlarged heads 388 of the pins 382 and 383. The spring 384 and the pins 382 and 383 are enclosed by a partially cylindrical (split lengthwise) pivot lock 390. The pivot lock 390 has lengthwise ribs 392 that snap into elongated depressions 394 on the swivel 336. The depressions 394 are longer than the pivot lock 390 so that it can slide from side to side when manipulated. A grip 396 at the outer surface makes facilitates sliding the pivot lock 390 with a thumb or finger. The pivot lock 390 also has an inner leg 398 with a semi-circular opening 400 that fits around the shaft of pin 382.

Both pins 382 and 383 can slide in and out of the swivel 336 against the spring 384 so that the cleaning head 312 can snap straight onto the coupler 332. As shown in FIG. 37, the pins 382 and 382 deflect inward as they come in contact with their associated mount 378 until they clear the contacting surfaces and are able to extending into the pivot holes 380 by the force of the spring 384. This is eased by the cammed ends 402 of the pins 382 and 383. The cammed ends 402 can be rounded, tapered or otherwise “softened” at the ends so as to facilitate the straight on connection of the cleaning head 312 to the device. In particular, the cammed ends 402 help transfer the forces arising from the longitudinal motion of joining the cleaning head 312 to the device to cause lateral movement of the pins 382 and 383 so that they retract against the spring 384. During assembly, the pins 382 and 383 both retract which brings their heads 388 closer together and causes the spring 384 to be compressed. The pins 382 and 383 retract independent of the pivot lock 390, which remains stationary during assembly. The resulting connection locks the cleaning head 312 to the coupler 332, and thus the body 306 of the device 300, while permitting front to back relative pivoting about the pivot axis 370. As shown in FIG. 35, sliding the pivot lock 390 from its resting position, preferably by using the grip 396, causes the leg 398 to abut the head 388 of pin 382 and thereby retract it against the spring 384. This allows the retracted pin 382 to clear its mount by manually pivoting the device up or to the side. The other pin 383 remains extended but can then be pulled out of the associated pivot hole to completely separate the cleaning head 312 from the coupler 332, and thereby the body 306 of the cleaning device 300.

It should be appreciated that preferred embodiments of the invention have been described above. However, many modifications and variations to these preferred embodiments will be apparent to those skilled in the art, which will be within the spirit and scope of the invention. Therefore, the invention should not be limited to the described embodiments. To ascertain the full scope of the invention, the following claims should be referenced.

### INDUSTRIAL APPLICABILITY

The invention is aerosol cleaning device having an improved pivotal connection for the cleaning head allowing rapid locking assembly and disassembly of the cleaning head.

We claim:

1. A cleaning device, comprising:
a handle having a lower connection portion with a pair of connecting pins that are resiliently biased outward in opposed directions; and
a cleaning head having an upper connection portion;
wherein the handle can be connected to the cleaning head by moving the lower connection portion in a linear manner down against the upper connection portion to thereby cause a snap lock connection therebetween and when so connected the handle is mounted to pivot relative to the cleaning head on a horizontal axis.

2. The cleaning device of claim 1, wherein when so connected the handle is also mounted to swivel relative to the cleaning head on an axis perpendicular to a plane in which the horizontal axis lies.

3. The cleaning device of claim 1, wherein outward ends of both of the pins are cammed so as to cause the pins to move inward towards each other as the lower connection portion is pressed against the upper connection portion.

4. The cleaning device of claim 3, wherein at least one of the pins can be manually slid against spring pressure towards the other pin to facilitate release of the handle from the cleaning head.

5. The cleaning device of claim 4, wherein the manually slidable pin is linked to a button having a dished portion.

6. The cleaning device of claim 5, wherein the button has a leg that engages the manually slidable pin.

7. The cleaning device of claim 1, wherein the handle is further linked to an aerosol canister assembly for delivering a chemical from the canister assembly to a desired location adjacent the cleaning head.

8. The cleaning device of claim 1, wherein the cleaning head is designed for mopping, and the device further comprises a replacement cleaning head designed for wall or window cleaning.
